(19) United States
(12) Patent Application Publication
(10) Pub. No.: US 2003/0064006 A1
(43) Pub. Date: Apr. 3, 2003

(54) Methods and systems for sealed parallel reactions

(76) Inventors: James Claude Carnahan, Niskayuna, NY (US); John Patrick Lemmon, Delanson, NY (US)

Correspondence Address: GENERAL ELECTRIC COMPANY, GLOBAL RESEARCH CENTER, PATENT DOCKET RM. 4A59, PO BOX 8, BLDG. K-1 ROSS, NISKAYUNA, NY, 12309, US

(21) Appl. No.: 09/682,652

(22) Filed: Oct. 2, 2001

(51) Int. Cl. G01N 31/10; B01J 19/00

(52) U.S. Cl. 422/99; 422/102; 422/119; 422/129; 422/130; 422/131; 422/196

(57) ABSTRACT

This invention relates to an apparatus and method for conducting and evaluating chemical reactions within the confines of a sealed experimental system. The invention allows for quantitative and qualitative analyses of contained reactions combinatorially or in a parallel array, with total conservation of mass throughout the reaction process. The analytical studies thus performed may be qualitative and/or quantitative, and may be obtained in real time during and/or following the reactive process.

### FEDERAL RESEARCH STATEMENT

This invention was made with government support under Contract No. DEFC0298CH10391 awarded by the Department of Energy. The government may have certain rights to the invention.

### BACKGROUND OF INVENTION

This invention relates to an apparatus and method for conducting and evaluating chemical reactions within the confines of a sealed experimental system. The invention allows for quantitative and qualitative analyses of contained reactions combinatorially or in a parallel array.

The evaluation of reactions of condensed phase (liquid or solid or mixtures thereof) reagents or catalysts with gases or vaporized materials has traditionally been performed in single tube reactors and the evolved products analyzed in realtime or collected and analyzed at a later time. This was sufficient in the past when generation of the condensed-phase catalysts or reagents was carried out one composition at a time. The advent of combinatorial synthesis techniques has lead to the ability to synthesize large numbers of potential catalysts or reagents that then must be evaluated for reactivity with the chosen gas-phase reagents and the products identified and measured. For example, this combinatorial technique may utilize a parallel flow-through gas-condensed phase reactor. The operation of multiple parallel flow-through gas-condensed phase reactors, however, requires either upstream flow control, which can be expensive and complicated, or the provision for insuring similar gas flow rates under the application of a fixed, common head pressure.

What are needed are devices and methods for conducting multiple simultaneous gas-condensed phase reactions. What is also needed is a device for conducting multiple simultaneous gas-condensed phase reactions, that require little effort between sets of reactions for connecting, disconnecting and getting ready for the next set of reactions. What is further needed is a device for conducting multiple simultaneous gas-condensed phase reactions, that has minimal infrastructure (i.e., temperature controls, temperature measurements, gas flows, gas feeds, gas feed flow controls, etc.). What is yet further needed is a device for analyzing the reaction products of multiple simultaneous gas-condensed phase reactions. Finally, what is needed is a device for real-time analysis of the reaction products of multiple simultaneous gas-condensed phase reactions.

### SUMMARY OF INVENTION

The present invention is a reaction system with at least one reaction vessel. The reaction system further comprises a temperature control means such as a temperature control block having at least a portion of the reaction vessel enclosed therein. In one embodiment, the reaction vessel has an inlet port and an exit port. Typically, the reaction vessel has a catalyst in at least one zone of the reaction vessel. In use, the reactants are introduced into the vessel and the ports are sealed. The temperature at the reaction site is adjusted to cause the reaction to proceed. The temperature at a different zone in the reaction vessel is adjusted to a desired temperature. The temperature at the second zone may be adjusted to collect the product of the reaction, to analyze the product of the reaction, and/or to separate products of the reaction.

Further aspects and advantages of the present invention will be more clearly apparent to those skilled in the art during the course of the following description, references being made to the accompanying drawings which illustrate some preferred forms of the present invention and wherein like characters of reference designate like parts throughout the drawings.

### BRIEF DESCRIPTION OF DRAWINGS

FIG. 1 is an illustration showing an exemplary embodiment of the present invention with a glass reactor tube containing a catalyst and reagent preparation prior to sealing the reactor tube.

FIG. 2 is an illustration showing an exemplary embodiment of the present invention with a glass reactor tube containing a catalyst and reagent preparation after the reactor tube has been sealed.

FIG. 3 shows a cross section of an exemplary embodiment of the present invention with a metal sealed reactor tube with spectroscopic windows.

FIG. 4 shows a cross section of an exemplary embodiment of the present invention with a detailed view of a reactor tube sealed with a metal end-fitting device, in which at least some of the reactor tube provides a transparent window for analysis of the contents therein.

FIG. 5 shows an end view of a end-fitting device according to an exemplary embodiment of the present invention.

FIG. 6 shows a cross section of an exemplary embodiment of the present invention with a detailed view of a reactor tube sealed with a metal end-fitting device, in which a transparent window is provided at the end of the reactor tube.

FIG. 7 is an illustration showing another exemplary embodiment of the present invention with a parallel reaction array using sealed tube vessels.

FIG. 8 is an illustration showing another exemplary embodiment of the present invention with a gas chromatography tracing of the synthesis of tetramethoxysilane from a sealed tube experiment.

FIG. 9 is an illustration showing another exemplary embodiment of the present invention with the background Raman spectrum in a sealed tube reactor before the reaction of dimethylcarbonate and diatomaceous earth.

FIG. 10 is an illustration showing another exemplary embodiment of the present invention with the product/condensate Raman spectrum in a sealed tube reactor following the reaction of dimethylcarbonate and diatomaceous earth to form tetramethoxysilane.

### DETAILED DESCRIPTION

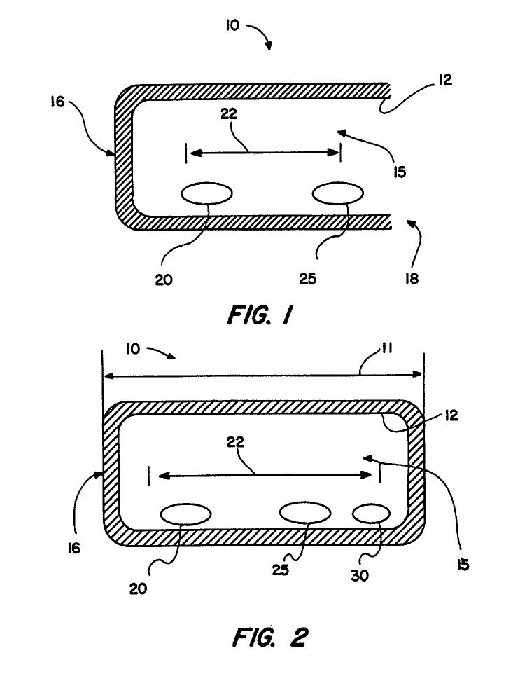

For the purposes of promoting an understanding of the principles of the invention, references will now be made to some of the preferred embodiments of the present invention as illustrated in FIGS. 1 through 6, and specific language used to describe the same. It will nevertheless be understood that no limitation of the scope of the invention is thereby intended. The terminology used herein is for the purpose of description and not limitation. Any modifications or variations in the depicted method or device, and such further applications of the principles of the invention as illustrated therein, as would normally occur to one skilled in the art, are considered to be within the spirit of this invention. For instance, features illustrated or described as part of one embodiment can be used on another embodiment to yield a still further embodiment. Thus, it is intended that the present invention cover such modifications and variations as come within the scope of the appended claims and their equivalents.

The present invention provides devices and methods for performing analysis of a catalytic or other chemical reaction, which is contained within at least one sealed vessels. The present invention is go_backgo_back particularly useful in the field of combinatorial chemistry in that it allows for a high throughput of reactants for producing a wide variety of compounds under controlled reaction conditions.

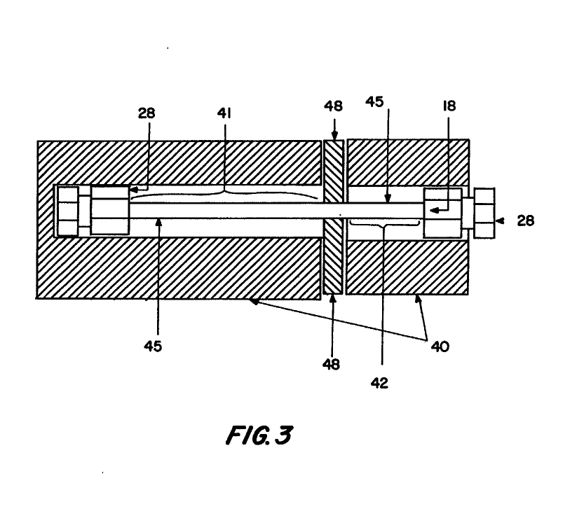

One embodiment of the present invention is shown in FIG. 1, wherein at least one sealed reactor tubes 10 are used as vessels to contain the chemical reaction. The reactor tubes 10 may be straight or curved, elongated hollow structures whose walls 12 define an internal lumen 15 with a closed end 16 and an open end 18. The walls 12 of the reactor tubes 10 are preferably constructed of heat resistant materials, including, but not limited to, glass, quartz, other crystals, metals or ceramics. The desired chemical catalyst 20 and reagent(s) 25 are placed within the lumen 15 of the reactor tubes 10, and the open ends 18 of the reactor tubes 10 are then sealed, as shown in FIG. 2. The sealing of the reactor tubes 10 containing the catalyst 20 and reagents 25 can be carried out in an appropriate atmosphere, such as at one atmosphere pressure, or the reagents can be frozen and the tube sealed under vacuum to eliminate the influence of atmosphere thermal expansion on total system pressure. One sealing technique used with glass or quartz reactor tubes 10 is similar to the automated processes currently used industrially for the sealing of glass electric lamp envelopes or light bulbs.

The sealed reactor tube 10 may then be used with a temperature gradient across the reactor tube 10 such that one end, containing the catalyst 20, is held at an elevated temperature to facilitate the desired reactions and the opposite end is at a lower temperature chosen to control the internal pressure of the reactor by condensing the reagents 25 or products 30 of the reaction or both reagents 25 and products 30. Thus, within the reactor tube 10, a cooler end 27 and a hotter end 29 may be defined. The location of the catalyst 20 within the reactor tube 10 defines the reaction zone 22 wherein the chemical reactions between the catalyst 20 and reagents 25 occurs. The temperature of the cooler end 27 and the volume fraction of the cooler end 27 along with the vapor pressures of the reagents 25 and products 30 determine their partial pressure in the reaction zone 22 within the sealed reactor tube 10. Thus, a low vapor pressure product might accumulate at the cooler end 27 of the tube. Desirably, such reactor tubes 10 may be oriented such that the cooler end 27 is level with or higher than the hotter end 29 to prevent transport of the catalyst 20 out of the reaction zone 22 and to facilitate revaporization of liquid reagents.

The sealed reactor tube 10 forms a reaction system that allows for multiple exposures of the reagents 25 to the catalysts 20 driven by a substantially constant or near constant vapor pressure of the reagents 25. This results in a greater yield of the products 30 of the reaction. Further, the small volume of reactants reduces the danger of potential explosions, fires, and other hazardous events.

The reactor tube 10 has a length 11 such that the hotter end 29 is of sufficient length to maintain the catalyst 20 in substantially isothermal conditions during the reaction. Further, the reactor tube 10 has a length 11 such that the cooler end 27 is of a sufficient length to retain the reagent 25 if such reagent 25 is a liquid. Preferably, the reactor tube 10 has a length 11 of about a few centimeters for easier handling. However, the reactor tube 10 may have a length 11, which is considerably longer.

Another embodiment of the present invention is shown in FIGS. 3-6, wherein at least one temperature-controlled block 40 holds metal demountable reactor tubes 45 that are used as reaction vessels. In this embodiment of the present invention, the reactor tubes 45 are constructed of stainless steel or special corrosion resistant metal alloys such as Hastelloy™. Each metal reactor tube 45 has one or more open ends 18, which are adapted to receive commercially available end fitting devices 28 including, but not limited to Swagelock™ (Swagelock, Solon, Ohio 44139), Parker™ (Parker Hannifin Corp., Jacksonville, Ala. 36265) or VICI™ (Valco Instruments Co., Inc., Houston, Tex. 77255) fittings as appropriate to the tube size. The coupling of such an end-fitting device 28 effectively seals the attached open end 18 of the metal reactor tube 45. Such an all-metal reactor tube systems can accommodate internal pressures up to 10,000 p.s.i. In alternate embodiments of the present invention, the metal reactor tube 45 may also have one or more closed ends 16 (FIG. 1), which may be sealed by welding or by the attachment of an end-fitting device 28. Alternately, the metal reactor tube 45 may be formed by a metal extrusion process with at least one closed end 16. In various embodiments, the metal reactor tubes 45 may be re-usable, or intended for single use, and may further be adapted to receive pressure control valves, as required by a given application.

The at least one temperature-controlled block 40 may include, for example, a hot region 41 and a cool region 42 separated by an insulating spacer 48. The hot region 41 is a zone of the block 40 corresponding to the hotter end 29 (FIG. 2) of the tube 45, while the cool region 42 is a zone corresponding to the cooler end 27 (FIG. 2) of the tube. The hot region 41 and cool region 42 may have independent temperature control within the parameters of a given reaction. The insulating spacer 48 may be a thermally insulating material, such as ceramic foam, glass or ceramic fiber mat, a wall of a less thermally conductive material such as glass or ceramic, or may simply be an air gap.

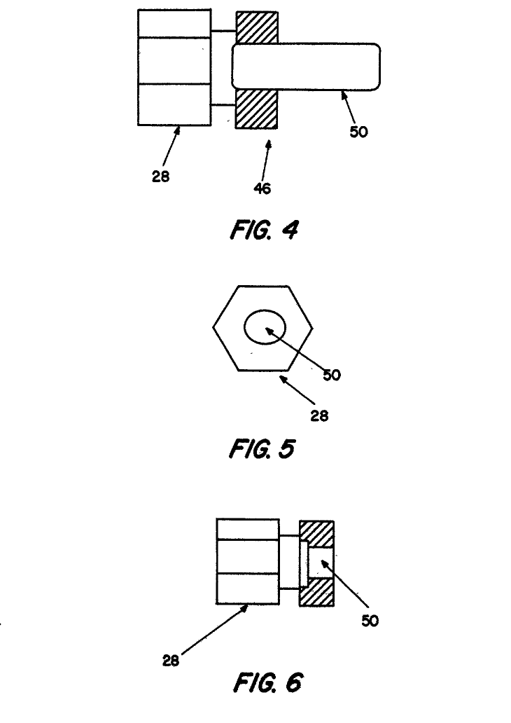

Referring to FIGS. 4-6, demountable metal reactor tubes 46 or end fitting 29, similar top end fitting 28, optionally can also be provided with at least one transparent windows 50 at selected locations along the length of the tube for analysis of the reaction progress or final results by spectroscopy or other analytical technologies. In such embodiments of the present device, spectroscopic technology can employ ultraviolet or visible light absorption, fluorescence, Raman scattering, infrared absorption, or near infrared absorption. Such window(s) 50 can be planar such as a disc set into the end fitting of a metal tube or the window(s) 50 can be transparent tubular elements longitudinally interposed between the open end 18 of the metal reactor tubes 45 and the end fitting device 28, permitting transmission measurements therethrough.

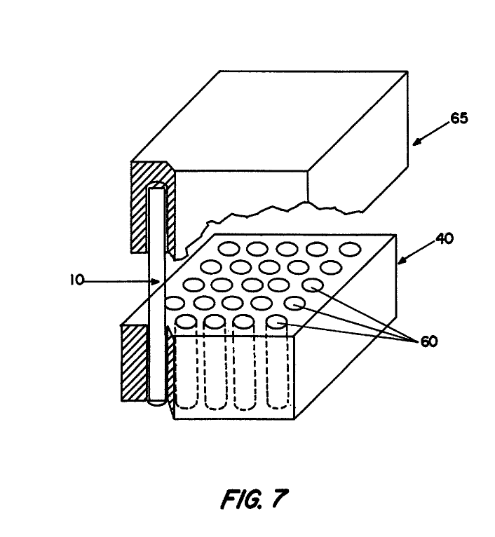

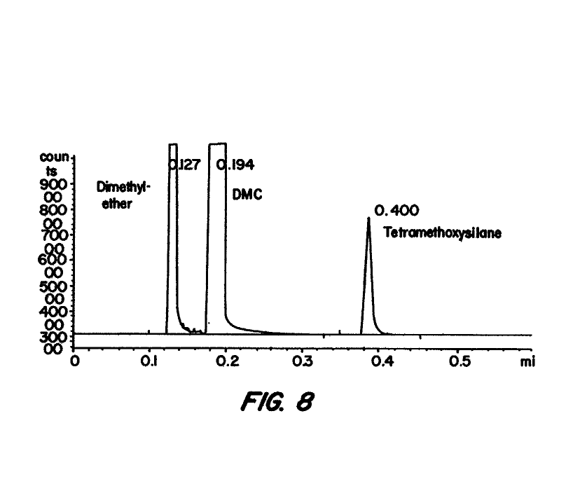

FIG. 7 illustrates a combinatorial reaction system 55 utilizing metal reactor tubes 10 or 45 (not shown) in conjunction with at least one temperature-controlled blocks 40 The blocks may be fashioned of metal with drilled or molded holes to accommodate the reactor tubes. The blocks may be segmented to provide close contact with the reactor tubes or the space between the reactor tubes and the block may be filled with a thermally conductive material. The temperature control system can be through circulating liquids or the blocks can be electrically heated with appropriate temperature control devices such as Digi-Sense Temperature controller (Part # U-89000-00, Cole Parmer Co., (.Vernon Hills, Ill. 60061). Cooling can be achieved by passing cool gas through passages in the cool block or liquid coolants can be used such as tap water or controlled temperature liquids generated by Chillers such as those manufactured by Neslab. It is to be understood that any method of controlling the temperature in at least one zone of the reaction vessels can be used according to the present invention. In such an application, a series of reactor tubes 10 are loaded with the desired catalyst 20. The starting reagent(s) 25 are introduced into the reactor tubes 10, and the apparatus is sealed under the chosen atmosphere. The tubes are inserted into an array of wells 60 within at least one temperature-controlled blocks 40. Such temperature-controlled blocks 40 provide heating, cooling, or thermal isolation as appropriate for the specific reaction involved.

In different embodiments of the present invention, referring to FIG. 7, the multiplicity of parallel reaction systems formed by reactor tubes 10 or 45 may vary from one to several hundred depending on the defined experimental or industrial needs. Preferably, the multiplicity can be up to ninety-six to take advantage of commercial robotic sample preparation and handling devices. The temperature of a heated temperature-controlled block 40 associated with the catalyst end optionally can be increased to reaction temperature and a second temperature-controlled block 65 associated with the reagent/product end optionally can be cooled to the chosen temperature to serve as a condenser. When the system is configured with two or more temperature-controlled blocks 40, insulating spacers 48 may be interposed between adjacent temperature-controlled blocks 40. The temperature-controlled blocks optionally can also be provided with access ports for fiber optic spectroscopic assemblies or other monitoring devices to analyze the reaction progress in real-time through windows 50 into or connected with the reactor tubes 10 or 45.

On completion of the reaction, for off-line analysis, the reactor system allows for cooling or freezing, if needed, to retain volatile components, and the reactor tubes can be opened and the contents analyzed by traditional chemical qualitative or quantitative analytical processes or technologies such as gas chromatography, liquid chromatography or combinations of these with attached specific detectors such as mass spectrometers, FTIR spectrometer, or other analytical instrumentation.

This invention is further illustrated by the following examples, which are not to be construed in any way as imposing limitations upon the scope thereof. On the contrary, it is to be clearly understood that resort may be had to various other embodiments, modifications, and equivalents thereof, which, after reading the description herein, may suggest themselves to those skilled in the art without departing from the spirit of the present invention.

Example 1 Example of reaction in glass reactor tubes.

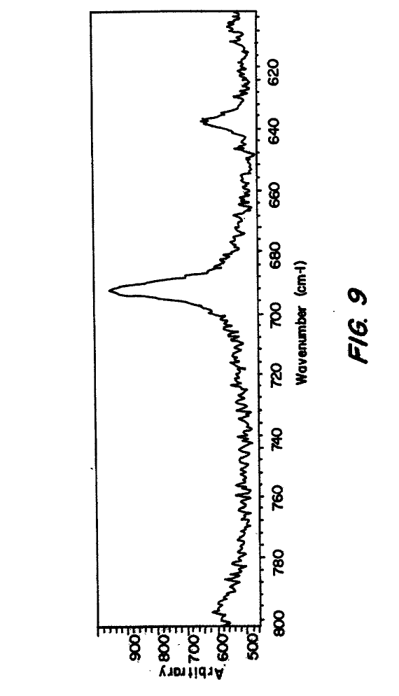

A 10 mm diameter Pyrex™ tube 320 mm long is sealed at one end and 20 mg of silica gel treated with 5% KOH is placed in the closed end, which will become the hotter end. Then, a location about 1.0 inch from the opposite end of the tube is necked down in a flame to facilitate later sealing. When the tube has cooled, 50 mg. of dimethyl carbonate is added to the tube with a syringe, adjacent to the necked-down area, which later form the hotter end of the tube. The closed end is cooled in liquid nitrogen and the tube evacuated to remove air and then the necked portion is sealed under active pumping at about 20 microns Hg total pressure. The end of the tube containing the catalyst is inserted through the wall of a gas chromatography oven at 320° C., such that the tube was inclined at about 15 degrees from horizontal and about 15 cm. of tube extending into the room with the cooler end higher than the hotter end. Active reflux of the liquid contents of the tube ensues in a few minutes and continues throughout the 90-minute reaction time. The condensate in the cool end typically would run down the tube and be revaporized in the hot zone. At the end of the reaction, the tube is cooled in liquid nitrogen, broken open and the contents taken up in 1 ml of ortho-dichlorobenzene for analysis by gas chromatography. Experimental gas chromatography results 80 from such a process are shown in FIG. 8 and are similar to what has been found in continuous flow reactors using a similar catalyst. The major products of the reaction of dimethylcarbonate 82 with activated silica at this temperature are tetramethoxysilane 84 and dimethylether 86.

### EXAMPLE 2

Example of Reaction in Steel with in-situ Spectroscopic Analysis.

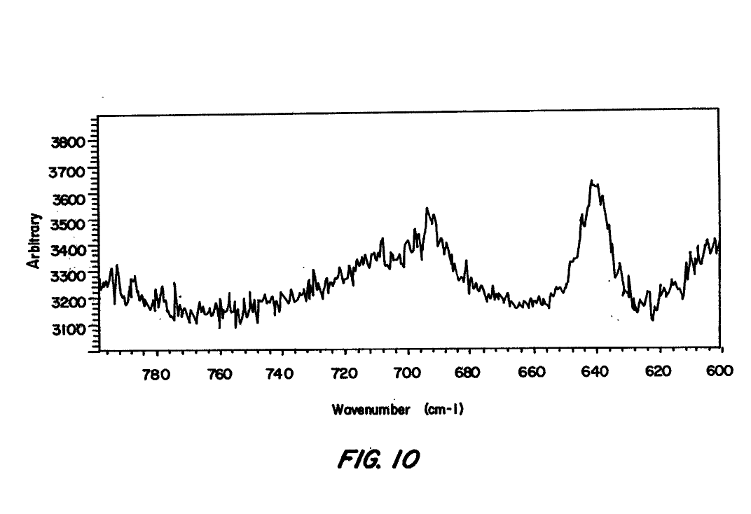

A ⅜-inch diameter stainless steel tube 10.0 inches in length is closed with Swagelock™ fittings. The heated end has a solid fitting applied, while the cool end is fitted with a quartz tube that protrudes 3 cm from the end fitting. The reaction is run in the same manner as for the glass tube described above with 210 mgm of dimethylcarbonate reacting with 100 mgm of treated diatomaceous earth at 350° C. for 90 minutes and the products analyzed by Raman spectroscopy without opening the tube. In FIG. 9, the Raman spectrum produced in this experiment shows the background spectrum 90 with a DMC peak 92 at the beginning of the reaction. FIG. 10 similarly shows the Raman spectrum 96 representing the condensate remaining at the end of the reaction. The spectrum in FIG. 10 shows a spike for the desired product of the reaction, tetramethoxysilane 98.

The overall intent of the present inventive reactor system is to provide a system for carrying out gas solid reactions or liquid solid reactions in individual containers that can be handled combinatorially or in a parallel array to allow the screening of catalysts, reactions, reaction conditions or reagents for high yield or for product generation. The system further allows for control of temperature of the reaction, exposure time of the gas to the reagent and control through temperature of a cool zone, and control of the partial pressure of the reagent gas over the reaction.

An additional major advantage of such sealed reactions is that there is total conservation of mass so the analysis at the end is simplified. In addition, the exposure of the reagents to catalysts is such that there can be multiple encounters of reagent with catalyst. Thus, in low yield reactions, substantial quantities of products can be produced as long as the desired products are not also reactants or other materials that might further react with the catalyst.

Those skilled in the art will now see that certain modifications can be made to the invention herein disclosed with respect to the illustrated embodiments, without departing from the spirit of the instant invention. In addition, while the invention has been described above with respect to the preferred embodiments, it will be understood that the invention is adapted to numerous rearrangements, modifications, and alterations, all such arrangements, modifications, and alterations are intended to be within the scope of the appended claims.

1. A reaction system, comprising:
at least one reaction vessel forming a sealed reaction chamber having a first end and a second end;
a plurality of reactants disposed within the at least one reaction vessel, a first portion of the plurality of reactants disposed in the first end of the sealed reaction chamber and a second portion of the plurality of reactants disposed in the second end of the sealed reaction chamber; and
a temperature-controlled device having an independently-controllable first end and an independently-controllable second end, the first end of said temperature-controlled device in thermal communication with the first end of the sealed reaction chamber and the second end of said temperature-controlled device in thermal communication with the second end of the sealed reaction chamber.

2. The reaction system of claim 1, wherein said reaction vessel is a tube.

3. The reaction system of claim 1, wherein one or more of said reactants is a catalyst.

4. The reaction system of claim 1, wherein said reaction vessel has an inlet port and an exit port.

5. The reaction system of claim 4, wherein said reaction vessel may be sealed at one or both said inlet and exit ports.

6. The reaction system of claim 5, wherein said reaction vessel contains one or more transparent windows to allow observation or analysis of the contents therein.

7. The reaction system of claim 1, wherein said independently controllable first end of said temperature-controlled device is hot, and wherein said independently controllable second end of said temperature-controlled device is cool.

8. The reaction system of claim 1, wherein said independently-controllable first end of said temperature-controlled device is cool, and wherein said independently-controllable second end of said temperature-controlled device is hot.

9. A reaction system, comprising:
at least one reaction vessel forming a sealed reaction chamber having a first end and a second end;
a plurality of reactants disposed within the at least one reaction vessel, a first portion of the plurality of reactants disposed in the first end of the sealed reaction chamber and a second portion of the plurality of reactants disposed in the second end of the sealed reaction chamber; and
a temperature-controlled device having an independently-controllable hot end and cool end, the hot end in thermal communication with the first end of the sealed reaction chamber and the cool end in thermal communication with the second end of the sealed reaction chamber.

10. The reaction system of claim 9, wherein said reaction vessel is a tube.

11. The reaction system of claim 9, wherein one or more of said reactants is a catalyst.

12. The reaction system of claim 9, wherein said reaction vessel has an inlet port and an exit port.

13. The reaction system of claim 12, wherein said reaction vessel may be sealed at one or both said inlet and exit ports.

14. The reaction system of claim 13, wherein said reaction vessel contains one or more transparent windows to allow observation or analysis of the contents therein.

15. A reaction system to perform analytical testing of chemical reactions wherein the reaction under study is contained within at least one closed reaction vessels.

16. The reaction system of claim 15, wherein the reaction vessels are constructed of tubular glass, quartz, stainless steel, other metal alloys, or other materials.

17. The reaction system of claim 15, wherein the reaction vessels may be sealed by heated fusion of the tubular construct material.

18. The reaction system of claim 15, wherein the reaction vessels may be mechanically sealed with an end-fitting device.

19. The reaction system of claim 18, wherein the reaction vessel is provided with at least one transparent port.

20. The reaction system of claim 18, wherein the end-fitting device is provided with at least one transparent port.

21. The reaction system of claim 18, wherein the reaction vessels are enclosed in whole or in part throughout their length by at least one temperature-controlled block.

22. A method of performing analytical chemical studies on a chemical reaction comprising utilizing at least one closed reaction vessels to contain the reacting reagents and any catalysts involved.

23. The method of claim 22, wherein the chemical reaction is analyzed by chromatography, spectrometry, or other electromagnetic analytical system.

24. A method of performing analysis of a chemical reaction in real time comprising combining the reagents and catalysts within a sealed reaction vessel which is adapted to allow spectral, chromatographic, or other quantitative or qualitative studies of the reaction within the container.

25. The method of performing analysis of claim 24, further comprising controlling the temperature within one or more portions of said reactor vessel.
